(19) United States
(12) Patent Application Publication
(10) Pub. No.: US 2020/0242580 A1
(43) Pub. Date: Jul. 30, 2020

(54) SHOPPING ASSISTANCE SYSTEM, SHOPPING ASSISTANCE METHOD, AND PROGRAM

(71) Applicant: Panasonic Intellectual Property Management Co., Ltd., Osaka (JP)

(72) Inventors: Koji IMAMURA, Tokyo (JP); Junichi TAKAHASHI, Osaka (JP); Masahiro KUMAGAWA, Hyogo (JP); Motoo NAKAGAWA, Tokyo (JP); Shinichi OKADA, Tokyo (JP)

(21) Appl. No.: 16/637,063

(22) PCT Filed: Sep. 26, 2018
(86) PCT No.: PCT/JP2018/035577

§ 371 Date: Feb. 6, 2020

(30) Foreign Application Priority Data
Sep. 29, 2017 (JP) 2017-191889

(51) Int. Cl. G06Q 20/20; G06Q 30/00; G06Q 10/08; G06K 7/10

(52) U.S. Cl. CPC G06Q 20/208; G06Q 30/0185; G06K 7/10366; G06Q 20/203; G06Q 10/087

(57) ABSTRACT

A shopping assistance system includes a strength acquirer and a determining processor. The strength acquirer is configured to acquire values of a received signal strength indication at a reader device while the reader device performs wireless communication with an electronic tag attached to at least one product. The reader device is configured to perform the wireless communication with the electronic tag by using a radio wave as a medium to read a piece of product information on the at least one product. The determining processor is configured to determine, for each of the at least one product, whether or not the at least one product is an object to be purchased based on a change of the received signal strength indication over time.

### TECHNICAL FIELD

The present disclosure relates to shopping assistance systems, shopping assistance methods, and programs, and specifically, to a shopping assistance system, a shopping assistance method, and a program which assist in shopping by use of electronic tags.

### BACKGROUND ART

Patent Literature 1 describes a Point Of Sales (POS) apparatus configured to perform at least a checkout (payment) process of a product to be purchased by a customer, which includes a reader device for reading a Radio Frequency (RF) tag (electronic tag). The electronic tag is attached to the product and stores price information or identification information of the product to which the electronic tag is attached.

In Patent Literature 1, the reader device reads information from the electronic tag in a state where the product is stored in an accommodation chamber having a shape of a box including six surfaces of a housing. The housing has an opening communicated with an inner space of the accommodation chamber. The opening is opened and closed with a lid member. That is, in a state where the lid member is held open, a customer can put the product in the accommodation chamber through the opening. The housing and the lid member are made of a material which reflects radio waves or a material which absorbs radio waves so that the reader device does not read one or more information pieces respectively on one or more electronic tags located outside the accommodation chamber.

With the configuration described in Patent Literature 1, however, the reader device may read the one or more information pieces respectively from the one or more electronic tags located outside the accommodation chamber, for example, when a radio wave from the one or more electronic tags located outside the accommodation chamber passes through the housing or the lid member, and when the lid member is forgotten to be closed. Thus, one or more products which are not objects to be purchased and which are present outside the accommodation chamber may be erroneously detected as the objects to be purchased.

### CITATION LIST

### Patent Literature

Patent Literature 1: JP2016-162177 A

### SUMMARY OF INVENTION

### Technical Problem

In view of the foregoing, it is an object of the present disclosure to provide a shopping assistance system, a shopping assistance method, and a program with which a product is less likely to be erroneously determination as an object to be purchased.

A shopping assistance system according to one aspect of the present disclosure includes a strength acquirer and a determining processor. The strength acquirer is configured to acquire values of received signal strength indication at a reader device while the reader device performs wireless communication with an electronic tag attached to at least one product. The reader device is configured to perform the wireless communication with the electronic tag by using a radio wave as a medium to read a piece of product information on the at least one product. The determining processor is configured to make, for each of the at least one product, a determination of whether or not the at least one product is an object to be purchased based on a change of the received signal strength indication over time.

A shopping assistance method according to one aspect of the present disclosure includes: acquiring values of received signal strength indication at a reader device while the reader device performs wireless communication with an electronic tag attached to at least one product; and determining, for each of the at least one product, whether or not the at least one product is an object to be purchased based on a change of the received signal strength indication over time. The reader device is configured to perform the wireless communication with the electronic tag by using a radio wave as a medium to read a piece of product information on the at least one product.

A program according to one aspect of the present disclosure is a program configured to cause a computer system to execute a process of acquiring values of received signal strength indication at a reader device while the reader device performs wireless communication with an electronic tag attached to at least one product and a process of determining whether or not at least one product is an object to be purchased. In the latter process, whether or not the at least one product is the object to be purchased is determined for each of the at least one product based on a change of the received signal strength indication over time. The reader device is configured to perform the wireless communication with the electronic tag by using a radio wave as a medium to read a piece of product information on the at least one product.

### BRIEF DESCRIPTION OF DRAWINGS

FIG. 1 is a block diagram schematically illustrating a configuration of a shopping assistance system according to a first embodiment;

FIG. 2 is an exterior perspective view illustrating a counter desk to which the shopping assistance system is applied;

FIG. 3 is a layout of a retail store in which the shopping assistance system is introduced;

FIG. 4 is a waveform diagram illustrating an example of a change of a received signal strength indication over time in the shopping assistance system;

FIG. 5 is a view schematically illustrating operation according to shopping by a customer based on the shopping assistance system;

FIG. 6A is a view schematically illustrating operation according to shopping by the customer based on a shopping assistance system according to a first comparative example of the first embodiment;

FIG. 6B is a view schematically illustrating operation according to shopping by the customer based on a shopping assistance system according to the first comparative example of the first embodiment;

FIG. 7 is a flow chart illustrating an operation of the shopping assistance system according to the first embodiment;

FIG. 8 is a view illustrating operation of the customer based on the shopping assistance system when the customer leaves the retail store;

FIG. 9 is an exterior perspective view illustrating a counter desk to which a shopping assistance system according to a second embodiment is applied;

FIG. 10 is an exterior perspective view illustrating a main part of a counter desk to which a shopping assistance system according to a variation of the second embodiment is applied; and

FIG. 11 is a view schematically illustrating a shopping assistance system according to a third embodiment.

### DESCRIPTION OF EMBODIMENTS

### First Embodiment

(1) Schema

A shopping assistance system according to the present embodiment is a system which is introduced into retail stores to assist customers in purchasing products (i.e., “shopping”). Examples of the retail stores include convenience stores, supermarkets, department stores, drugstores, electronics retail stores, hardware stores, and the like.

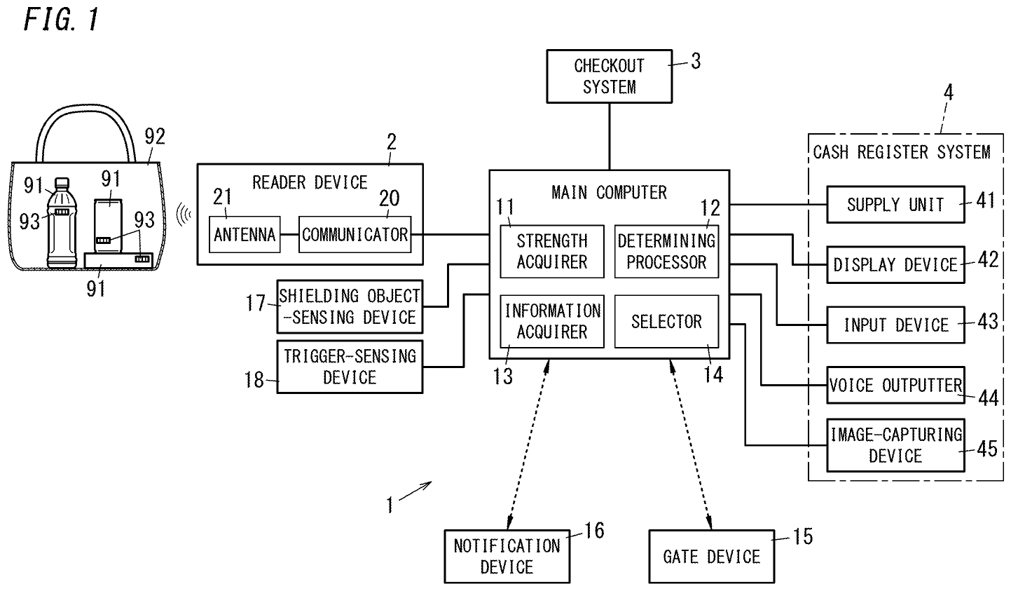

As illustrated in FIG. 1, the shopping assistance system 1 includes a strength acquirer 11 and a determining processor 12. The strength acquirer 11 acquires values of Received Signal Strength Indication (RSSI) at a reader device 2 while the reader device 2 performs wireless communication with an electronic tag 93 attached to at least one product 91. The reader device 2 is a device configured to perform the wireless communication with the electronic tag 93 by using a radio wave as a medium to read a piece of product information on the at least one product 91. The determining processor 12 is configured to make, for each of the at least one product 91, a determination whether or not the at least one product 91 is an object to be purchased based on a change of the received signal strength indication over time. In the present embodiment, the reader device 2 is included in components of the shopping assistance system 1. However, the reader device 2 does not have to be included in the components of the shopping assistance system 1.

As used herein, the “product information” is information for identifying a product, and may be a goods (or product) identification code such as Japanese Article Number (JAN) code used in Japan. Examples of the product identification code further include European Article Number (EAN) code used in Europe and the like and Universal Product Code (UPC) used in USA and the like in addition to the JAN code. The piece of product information read by the reader device 2 is used in, for example, a checkout process performed by a checkout system 3. That is, the reader device 2 does not read the piece of product information directly from a product 91 but reads the piece of product information in a non-contact manner from the electronic tag 93 attached to the product 91.

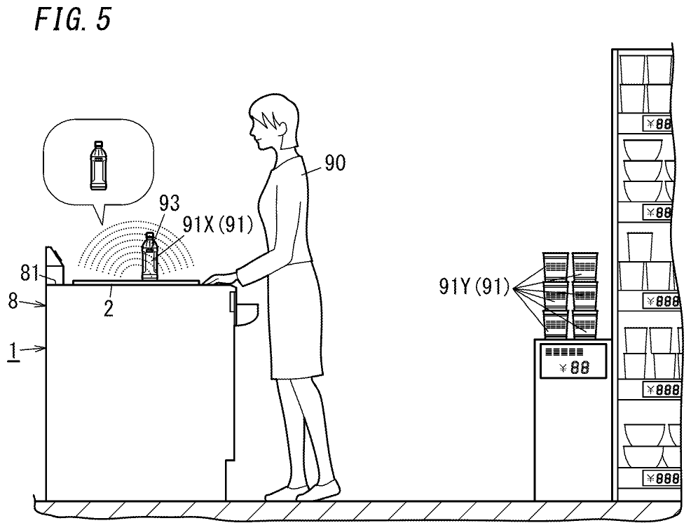

Moreover, as used herein, the “object to be purchased” means a product 91 as an object to be purchased by a customer 90 (see FIG. 5). As used herein, “purchase” refers to actions taken by a buyer (customer) of actions (sales and purchase) of transferring the ownership of one or more products 91 from a seller (store) to the buyer (customer) and paying the seller the consideration (charge) for the one or more products 91 by the buyer. That is, completion of a checkout process of a product 91 as an object to be purchased basically means that the ownership of the product 91 is transferred from the seller (store) to the buyer (customer), and the customer 90 may bring back the product 91.

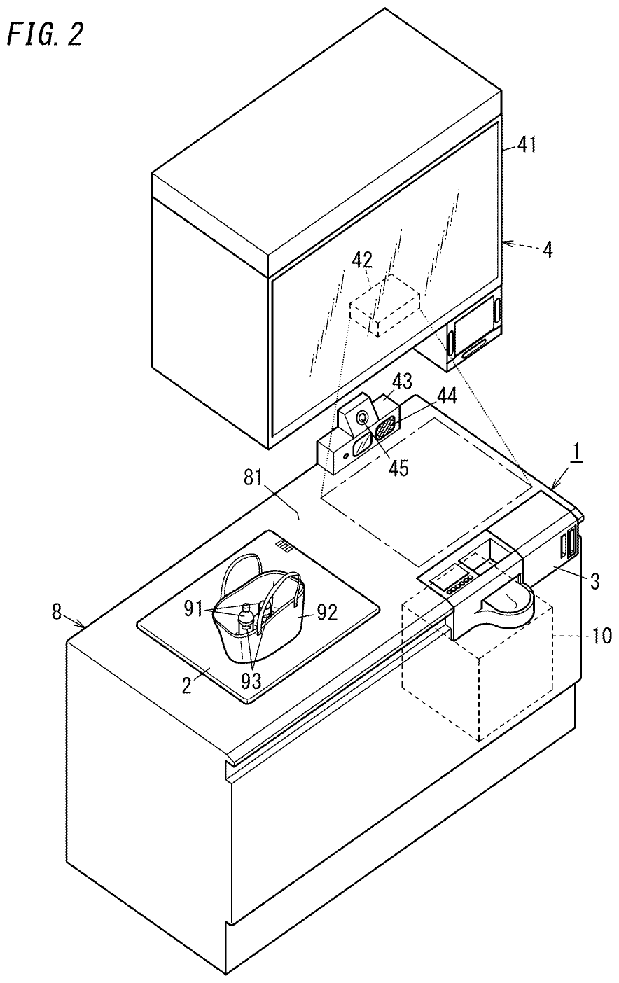

In the shopping assistance system 1, the reader device 2 installed at a checkout counter 8 (see FIG. 2) in a retail store reads the piece of product information in a non-contact manner, thereby achieving a state where checkout of the at least one product 91 is possible, for example. Thus, for example, it is possible to collectively read a plurality of pieces of product information on a plurality of products 91, and it is possible to read a piece of product information also in a state where at least one product 91 is in a shopping bag (a so-called plastic shopping bag) or the like. Accordingly, it is possible to save labor that has to be performed by a sales clerk and a customer 90 for shopping by the customer 90 as compared to a case where product information is read from, for example, a barcode.

Here, in the shopping assistance system 1 according to the present embodiment, it is determined whether or not the at least one product 91 is an object to be purchased for each of the at least one product 91 based on the change of the received signal strength indication over time while the reader device 2 performs wireless communication. That is, in the shopping assistance system 1, the strength acquirer 11 acquires values of the received signal strength indication of a wireless signal at the reader device 2 when the reader device 2 performs the wireless communication with the electronic tag 93 attached to the at least one product 91 to read the piece of product information. Then, in the shopping assistance system 1, the determining processor 12 determines whether or not the at least one product 91 is the object to be purchased for each of the at least one product 91 based on a variation (change) of the received signal strength indication (over time).

For example, when the reader device 2 is installed at the checkout counter 8 in a retail store, the customer 90 picks up at least one product 91 as an object to be purchased from a plurality of products 91 displayed in the retail store, brings the at least one product 91 to the checkout counter 8, and puts the at least one product 91 in a prescribed area on the checkout counter 8. Due to a series of such actions taken by the customer 90, the distance from the reader device 2 to the object to be purchased decreases as the customer 90 holding the object to be purchased (the at least one product 91) approaches the checkout counter 8, and after the object to be purchased is put on the prescribed area, the distance from the reader device 2 to the object to be purchased is fixed. Thus, along the series of the above-described actions taken by the customer 90, values of the received signal strength indication acquired while the reader device 2 performs wireless communication with the electronic tag 93 attached to the at least one product 91 as the object to be purchased show a specific changing pattern for the at least one product 91. For example, as illustrated in FIG. 2, the received signal strength indication for the at least one product 91 as the object to be purchased shows a specific changing pattern in which the received signal strength indication exponentially rises, and in a subsequent specified time, a variation width converges within a prescribed width. Thus, the shopping assistance system 1 is configured to identify the at least one product 91 put in the prescribed area as a product as the object to be purchased by analyzing the change of the received signal strength indication over time.

Thus, in the shopping assistance system 1, for example, the reader device 2 may read pieces of product information on products 91 which are, for example, products 91 displayed in the vicinity of the checkout counter 8 and which are not objects to be purchased, but the at least one product 91 as the object to be purchased can be distinguished from these products 91. Then, in the shopping assistance system 1, only the at least one product 91 identified as the object to be purchased is subjected to, for example, a checkout process performed by the checkout system 3, thereby suppressing the products 91 which are not the objects to be purchased from being subjected to the checkout process. Thus, the shopping assistance system 1 provides the advantage that even though the reader device 2 may read pieces of product information from electronic tags 93 located out of the prescribed area, erroneous determination as objects to be purchased is less likely to occur.

(2) Details

The shopping assistance system 1 according to the present embodiment will be explained in detail below. In the present embodiment, a convenience store is exemplified as a store which the shopping assistance system 1 is introduced into.

(2.1) Shopping Assistance System

Herein, the overall structure of the shopping assistance system 1 according to the present embodiment will be first explained.

As illustrated in FIGS. 1 and 2, the shopping assistance system 1 includes a main computer 10, the reader device 2, the checkout system 3, and a cash register system 4. However, it is not essential that the reader device 2 is included in the components of the shopping assistance system 1 as described above. The checkout system 3 and the cash register system 4 are also not essential components of the shopping assistance system 1. Moreover, in the present embodiment, the shopping assistance system 1 further includes a gate device 15, a notification device 16, a shielding object-sensing device 17, and a trigger-sensing device 18 which are also not essential components of the shopping assistance system 1.

The main computer 10 includes the strength acquirer 11, the determining processor 12, an information acquirer 13, and a selector 14. In the present embodiment, the main computer 10 is a computer system including a processor and memory as hardware as main components. In the main computer 10, the processor executes a program stored in the memory to realize functions of the strength acquirer 11, the determining processor 12, the information acquirer 13, and the selector 14. The program may be stored in the memory of the main computer 10 in advance, may be provided over a telecommunications network, or may be provided as a non-transitory recording medium such as an optical disc or hard disk drive which stores the program and which is readable by the computer system.

The main computer 10 is connected to the reader device 2 and the checkout system 3. Moreover, the main computer 10 is configured to communicate with a store terminal including, for example, a Point Of Sales (POS) terminal. The main computer 10 performs, based on product information received from the reader device 2 by the information acquirer 13, a prescribed process such as a transmission process of transmitting, to the checkout system 3, information required for the checkout process performed by the checkout system 3.

The strength acquirer 11 is configured to acquire values of received signal strength indication at the reader device 2 while the reader device 2 performs wireless communication. The strength acquirer 11 acquires values of the received signal strength indication from the reader device 2. Here, when the reader device 2 simultaneously reads pieces of product information on a plurality of products 91, the strength acquirer 11 acquires the value of the received signal strength indication with respect to each of the products 91. The strength acquirer 11 acquires the values of the received signal strength indication at constant time intervals (for example, 100 milliseconds) from the reader device 2 and stores it in the memory of the main computer 10.

The determining processor 12 is configured to determine, for each of the products 91, whether or not the product 91 is an object to be purchased based on a change of the received signal strength indication over time. Here, the determining processor 12 analyzes the change of the received signal strength indication during a determination time period for each of the products 91 and determines, based on an analysis result, whether or not each of the products 91 is the object to be purchased. In the present embodiment, the determining processor 12 analyzes a changing pattern of the received signal strength indication during the determination time period stored in the memory of the main computer 10 to determine whether or not the products 91 are the objects to be purchased. As used herein, the “determination time period” is a time period having a prescribed length (for example, 10 seconds) before and after a time point at which a trigger is sensed by a trigger-sensing device 18 which will be described later.

The information acquirer 13 acquires pieces of product information on a plurality of products 91 from the reader device 2. When wireless communication with electronic tag 93 attached to a product 91 is established, the reader device 2 receives, from the electronic tag 93, a piece of product information on the product 91 provided with the electronic tag 93, which will be described later in detail. The information acquirer 13 acquires, from the reader device 2, the piece of product information read (received) in this way by the reader device 2 from the electronic tag 93. Here, when the reader device 2 simultaneously reads pieces of product information on a plurality of products 91, the information acquirer 13 acquires the pieces of product information on the plurality of products 91 one by one. The information acquirer 13 acquires the product information at constant time (for example, 100 milliseconds) intervals from the reader device 2 and stores it in the memory of the main computer 10.

The selector 14 selects a piece of product information on at least one object to be purchased from the plurality of pieces of product information based on a determination result by the determining processor 12. That is, when the information acquirer 13 acquires the plurality of pieces of product information on the plurality of products 91 from the reader device 2, the selector 14 selects the piece of product information on the at least one product 91 as the object to be purchased from the plurality of pieces of product information. The selector 14 may select two or more pieces of product information as the pieces of product information on the objects to be purchased.

Moreover, the selector 14 is configured to output the piece of product information on the object to be purchased to the checkout system 3 configured to perform the checkout process on the at least one product 91. That is, the main computer 10 outputs, to the checkout system 3, the piece of product information which is information on the object to be purchased and which is selected by the selector 14. This enables only the at least one product 91 identified as the object to be purchased to be subjected to the checkout process performed by the checkout system 3.

Specifically, when receiving product information from the reader device 2 by the information acquirer 13, the main computer 10 acquires, together with the product information, values of the received signal strength indication from the reader device 2 by the strength acquirer 11. That is, the main computer 10 receives combinations of pieces of product information and the values of the received signal strength indication from the reader device 2 at constant time (for example, 100 milliseconds) intervals. When receiving the combinations of the pieces of product information and the values of the received signal strength indication, the main computer 10 stores the values of the received signal strength indication corresponding to a storage time period (for example, one minute) in the memory of the main computer 10 for each piece of product information. Thus, the memory of the main computer 10 stores, for example, as shown in Table 1 below, the values of the received signal strength indication for each product 91, that is, for each of the pieces of product information (“aaaa”, “bbbb”, “cccc”). In Table 1, “t1” to “t8” represent times at which the values of the received signal strength indication are acquired. The values of the received signal strength indication stored in the memory of the main computer 10 according to the above described manner may be deleted not only when the storage time period expires but also, for example, when the pieces of product information can no longer be received.

TABLE 1

| Product | Received Signal Strength Indication | | | | | | | |
|---|---|---|---|---|---|---|---|---|
| Information | t1 | t2 | t3 | t4 | t5 | t6 | t7 | t8 |
| aaaa | 10 | 11 | 11 | 15 | 11 | 10 | 11 | 10 |
| bbbb | 78 | 80 | 77 | 80 | 80 | 82 | 90 | 85 |
| cccc | 158 | 160 | 160 | 183 | 211 | 255 | 310 | 315 |

As in Table 1, in the main computer 10, the determining processor 12 analyzes the change of the received signal strength indication during the determination time period for each product 91, based on the values of the received signal strength indication corresponding to the storage time period and stored in the memory for each of the pieces of product information. The determining processor 12 compares an analysis result with a prescribed determination condition to determine whether or not each product 91 is the object to be purchased. As used herein, the “determination condition” means a condition based on which the determining processor 12 determines that a product 91 is the object to be purchased. In the present embodiment, the determination condition includes two conditions, namely, a first condition and a second condition, and when the analysis result by the determining processor 12 satisfies both the first condition and the second condition, it is determined that a product 91 is the object to be purchased, which will be described later in detail. The first condition is that a rise of the received signal strength indication is detected. The second condition is that the variation width of the received signal strength indication for a specified time (for example, one second) is smaller than or equal to the prescribed width. If it is determined that a product 91 is the object to be purchased, the selector 14 of the main computer 10 outputs, to the checkout system 3, a piece of product information on the product 91 as product information of the object to be purchased.

Moreover, the main computer 10 is configured to communicate with the cash register system 4, the gate device 15, the notification device 16, the shielding object-sensing device 17, and the trigger-sensing device 18 to control these devices.

The cash register system 4 includes a supply unit 41, a display device 42, an input device 43, a voice outputter 44, and an image-capturing device 45. The supply unit 41, the display device 42, the input device 43, the voice outputter 44, and the image-capturing device 45 are each a peripheral device of the main computer 10 and are connected to the main computer 10.

The supply unit 41 is a device configured to supply specific products (for example, cigarettes) to customers 90. The display device 42 is a device configured to display various types of information for customers 90. The input device 43 is a device configured to receive operations given by customers 90 by, for example gesture detection. Moreover, the input device 43 includes a microphone and has a function of applying voice recognition and semantic analysis to a voice signal input from the microphone. Thus, a voice operation (voice input) by the customer 90 is also possible. The voice outputter 44 includes a loudspeaker and is configured to provide customers 90 with various kinds of information by the voice.

That is, the cash register system 4 uses the display device 42, the input device 43, and the voice outputter 44 as user interfaces to provide customers 90 with various kinds of information by the display or the voice and to receive operations (including voice input) given by the customers 90. Note that such information is represented by at least one of the display or the voice, or may be represented by a combination of the display and the voice by the cash register system 4.

For example, the cash register system 4 may provide customers 90 with messages such as “Welcome” and “Thank you very much” respectively at a timing at which a customer is detected and at a timing at which the checkout process is completed. In this way, it is possible to give customers 90 a sense of affinity like clerk service. For example, a customer 90 is to operate the input device 43 to select one of payment methods to pay the checkout amount displayed on the display device 42. The cash register system 4 may also provide customers 90 with a utilization procedure for the shopping assistance system 1 by the display device 42 and the voice outputter 44. In this case, for example, when a customer comes, the display device 42 and the voice outputter 44 explain each step of the utilization procedure sequentially, for example, at first prompt the customer to put a product 91, and then confirm whether or not the fast food or the cigarettes are purchased, etc.

Moreover, the image-capturing device 45 is a camera which captures images of a space in front of the checkout counter 8 (see FIG. 2) and a space above an upper surface 81 (see FIG. 2) of the checkout counter 8. For example, the image-capturing device 45 captures an image of a customer 90 when the customer 90 is present in front of the checkout counter 8, and the image-capturing device 45 captures an image of the product 91 when the product 91 is put on the checkout counter 8.

The reader device 2 is a device configured to perform the wireless communication with an electronic tag 93 attached to the product 91 by using a radio wave as a medium to read the piece of product information on the product 91. The reader device 2 includes an antenna 21 and a communicator 20. The reader device 2 has a rectangular plate shape, which will be described later in detail. Basically, in a state where a product 91 is put in the prescribed area defined on a surface (upper surface) of the reader device 2, the reader device 2 performs wireless communication with an electronic tag 93 attached to the product 91 and executes reading of the piece of product information. The electronic tag 93 is a Radio Frequency (RF) tag, and the reader device 2 does not read product information directly from a product 91 but reads the product information in a non-contact manner from an electronic tag 93 attached to the product 91.

In the present embodiment, the reader device 2 reads the piece of product information from the electronic tag 93 attached to at least one product 91 in a state where the at least one product 91 is stored (bagged) in a container 92 (see FIG. 2). Thus, a customer 90 picks up at least one product 91 in a store and stores the picked up product 91 in the container 92 and then, puts the container 92 containing the at least one product 91 in the prescribed area on the reader device 2, thereby causing the reader device 2 to read the piece of product information. Accordingly, the customer 90 does not have to perform bagging after reading of the piece of product information and can bring back to home the container 92 with the at least one product 91 being stored in the container 92. In this way, the shopping assistance system 1 enables shopping to be efficiently performed. As used herein the “container” is at least a case which is used by a customer 90 to bring at least one product to home, which has a size that allows at least one product 91 to be put in, which has an opening through which at least one product 91 is put in or taken out, and which is, for example, a bag, a basket, a box, or a cart.

In particular, in the present embodiment, the container 92 is assumed to be a personal bag (including, for example, a reusable shopping bag) of a customer 90. Thus, the customer 90 may store the at least one product 91 in the container 92 when the customer 90 picks up the at least one product 91, and therefore, it is possible to simultaneously perform picking up and bagging of the at least one product 91. Thus, the shopping assistance system 1 no longer requires the action “bagging” alone and thus can further improve the efficiency of shopping. However, it is not essential for the shopping assistance system 1 that the customer 90 simultaneously performs picking up of the at least one product 91 and bagging of the at least one product 91. For example, the customer 90 may bag the at least one product 91 after picking up the at least one product 91 until the checkout process is started, or the customer 90 may bag the at least one product 91 after the checkout process.

Moreover, as illustrated in FIG. 2, when a plurality of products 91 are stored in the container 92, the reader device 2 can collectively read pieces of product information on the plurality of products 91 from a plurality of electronic tags 93 attached to the plurality of products 91. Here, the reader device 2 may collectively acquire the plurality of pieces of product information from the plurality of electronic tags 93 or may acquire pieces of product information one by one. Thus, when the customer 90 once stores the plurality of products 91 in the container 92, the plurality of products 91 are then handled collectively, without being handled as individual products, until the checkout process is completed, and the customer 90 brings the plurality of products 91 to home.

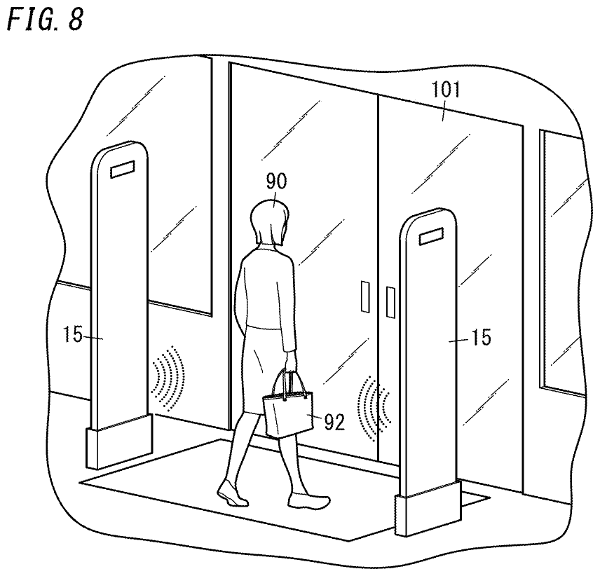

In a similar manner to the reader device 2, the gate device 15 is configured to perform wireless communication with an electronic tag 93 attached to a product 91 by using a radio wave as a medium to read product information. The gate device 15 is installed at, for example, an exit/entrance 101 (see FIG. 8) of a retail store which is a sales space. The gate device 15 is configured to wirelessly perform two-way communication with the main computer 10 by using a radio wave as a medium. When the customer 90 passes through the exit/entrance 101 to go out of the retail store (exits the retail store), the gate device 15 communicates, in a non-contact manner, with the electronic tag 93 attached to the at least one product 91 in the container 92 held by the customer 90. At this time, it is determined whether or not the checkout process has been performed on the piece of product information read by the gate device 15 from the electronic tag 93. In the present embodiment, whether or not the checkout process of the at least one product 91 has been completed is determined, for example, based on the value of a checkout completion flag stored in association with the piece of product information in the memory of the main computer 10. For example, if the checkout process of a product 91 has been completed, the value of the checkout completion flag for the product 91 is “1”. Thus, when the checkout completion flag corresponding to the piece of product information read from the electronic tag 93 by the gate device 15 is “0”, it is determined that the checkout process is incomplete, and when the checkout completion flag corresponding to the piece of product information is “1”, it is determined that the checkout process is completed.

The notification device 16 executes a notification process when the piece of product information read by the gate device 15 is not subjected to the checkout process. That is, with the gate device 15 and the notification device 16, it is possible to confirm that the checkout process of a product 91 which is about to be brought out of the retail store has normally been completed. The notification device 16 is formed integrally with the gate device 15, for example. Modes of notification performed by the notification device 16 are not particularly limited, but, for example, the notification device 16 itself may perform the notification by display or voice, or the notification device 16 may transmit a notification signal to the main computer 10 to cause the cash register system 4 or the like to perform the notification.

The shielding object-sensing device 17 senses the presence and absence of a shielding object shielding a radio wave between the reader device 2 and the electronic tag 93. When the shielding object-sensing device 17 senses the shielding object, the main computer 10 temporarily interrupts the determining process performed by the determining processor 12, which will be described later in detail. As used herein, the “shielding object” is an object (including a human body) which at least reduces the received signal strength indication of a radio wave from the electronic tag 93 at the reader device 2 and which does not have to completely shield the radio wave. Specific examples of the shielding object include a person (including a customer 90) and an object (a hand truck or the like) that passes between the reader device 2 and a product 91 (electronic tag 93). The shielding object-sensing device 17 is realized, for example, as a motion detector (for example, pyroelectric sensor, or image sensor) configured to sense a person who passes in front of the checkout counter 8. Alternatively, the shielding object-sensing device 17 may be realized, for example, as an objective sensor (for example, optical sensor or radio wave sensor) configured to sense an object that passes in front of the checkout counter 8. The shielding object-sensing device 17 may also serve as the image-capturing device 45 of the cash register system 4.

The trigger-sensing device 18 is configured to sense that a product 91 is put in the prescribed area. When the trigger-sensing device 18 senses putting of a product 91 in the prescribed area as a “trigger”, the main computer 10 starts the determining process by the determining processor 12, which will be described later in detail. As used herein, the “prescribed area” means an area in which a product 91 whose product information is to be read by the reader device 2 is put. The trigger-sensing device 18 is realized, for example, as a motion detector (for example, a pyroelectric sensor or an image sensor) configured to sense a customer 90 who stops in front of the checkout counter 8. Alternatively, the trigger-sensing device 18 may be realized, for example, as an objective sensor (for example, a weight sensor, an optical sensor, an acceleration sensor, or an image sensor) configured to sense a product 91 put on the reader device 2. The image-capturing device 45 of the cash register system 4 may be used also as the trigger-sensing device 18.

Here, as illustrated in FIG. 2, the shopping assistance system 1 is provided, for example, in the periphery of the checkout counter 8 in a retail store. One store may be provided with a plurality of checkout counters 8.

In the following description, the checkout counter 8 is installed in an orientation in which the upper surface 81 of the checkout counter 8 is a horizontal surface unless otherwise noted. That is, a direction orthogonal to the upper surface 81 of the checkout counter 8 is the up-down direction (gravity direction). Moreover, in the following description, left and right directions when the checkout counter 8 is viewed from the front is defined as “left and right directions”, and a depth direction of the checkout counter 8 is defined as the “forward and rearward directions”. Note that these directions are not to limit the directions of the shopping assistance system 1 in use. For example, the shopping assistance system 1 may be used with the upper surface 81 of the checkout counter 8 being slightly tilted to a horizontal surface.

In the example shown in FIG. 2, the main computer 10 is built in the checkout counter 8. In the example shown in FIG. 2, the main computer 10 is built in a location on a right end side when the checkout counter 8 is viewed from the front.

The reader device 2 is disposed on the upper surface 81 of the checkout counter 8 at an area between a central part and a left end in a width direction (left and right directions). Here, the reader device 2 is fixed to a fixed position (on the upper surface 81 of the checkout counter 8). Thus, for example, the customer 90 stands in front of the checkout counter 8 and puts at least one product 91 on the plate-like reader device 2 having a plate shape and installed on the upper surface 81 of the checkout counter 8, and thereby, the customer 90 can cause the reader device 2 to read the piece of product information on the at least one product 91.

The supply unit 41 is suspended from a ceiling to be provided above the checkout counter 8. The display device 42 is fixed to a lower surface of the supply unit 41 and is configured to project an image onto a screen by, for example, a projection mapping technique. Herein, the display device 42 projects an image onto a right region with respect to the reader device 2 in the upper surface 81 of the checkout counter 8 as viewed from the front side of the checkout counter 8. That is, the right region with respect to the reader device 2 in the upper surface 81 of the checkout counter 8 serves as a screen of the display device 42. The input device 43 is on the upper surface 81 of the checkout counter 8 and is disposed behind the screen as viewed from the front side of the checkout counter 8. The input device 43 is provided integrally with the voice outputter 44.

Moreover, the positional relationship, shapes, and the like of components of the shopping assistance system 1 described above are mere examples and may accordingly be modified. For example, when the checkout counter 8 is viewed from the front, the reader device 2 may be disposed on the right side, the main computer 10 may be disposed on the left side, and the checkout counter 8 may have an L-shape in plan view. Alternatively, for example, the reader device 2 may be provided separately from the checkout counter 8.

(2.2) Reader Device

Next, the reader device 2 will be described in detail.

The reader device 2 is configured to read product information from an electronic tag 93 attached to a product 91 to acquire the product information. That is, the reader device 2 performs wireless communication with the electronic tag 93 attached to the product 91 by using a radio wave as a medium to acquire the product information stored in the electronic tag 93.

The electronic tag 93 is, for example, a passive-type RF tag and has memory for storing at least the product information. Herein, a plurality of electronic tags 93 are associated with a plurality of products 91 on a one-to-one basis. Each of the electronic tags 93 stores a piece of product information on a corresponding one of the products 91. Each of the electronic tags 93 is attached to the corresponding one of the products 91.

Each electronic tag 93 is attached to the product 91 at least in a state where the electronic tag 93 can be handled together with the product 91. Examples of a specific method for attaching the electronic tag 93 to the product 91 include various types of methods. In the present embodiment, for example, the electronic tags 93 are seals and are put on the products 91. Alternatively, for example, the electronic tags 93 may be connected to the products 91 by strings or the like, may be integrated with wrapping materials of the products 91, may be embedded in the products 91, or may be incorporated into the products 91. Alternatively, for example, by using a technique such as an application-type semiconductor, the electronic tags 93 may be formed directly on the products 91 themselves or on surfaces of wrapping materials or the like of the products 91 by printing.

As illustrated in FIG. 2, the reader device 2 according to the present embodiment has a rectangular plate shape and is fixed to the upper surface 81 of the checkout counter 8. The reader device 2 is a reader which includes the antenna 21 and the communicator 20 therein (see FIG. 1) and which is included in a Radio Frequency Identification (RFID) system. The reader device 2 basically performs wireless communication with the electronic tag 93 of the product 91 put in the prescribed area above the reader device 2. In the present embodiment, the reader device 2 is a so-called open-type reader device which is not provided with a shield or the like to reduce leakage of the radio wave from the prescribed area.

The antenna 21 transmits and receives a radio wave serves as a communication medium between the antenna 21 and the electronic tag 93 located in the prescribed area on the reader device 2 to perform wireless communication. That is, in the present embodiment, the antenna 21 is disposed below the process area so as to be able to transmit and receive the radio wave to and from the process area. The antenna 21 preferably includes an antenna for a circular polarized wave with a polarized wave surface being taken into consideration. The antenna 21 is electrically connected to the communicator 20. The antenna 21 is, for example, a patch antenna, a monopole antenna, an inverted-F antenna, or a slot antenna.

Note that in the present embodiment, the reader device 2 is an open-type. Therefore, a structure for restricting a range within which the radio wave transmitted from the antenna 21 reaches is not particularly provided. Thus, a radio wave for communication output from the antenna 21 may reach products which are present out of the prescribed area, such as products placed in the vicinity of the checkout counter 8, for example. Accordingly, the reader device 2 may read pieces of product information from the products which are present out of the prescribed area, such as the products placed in the vicinity of the checkout counter 8.

The communicator 20 transmits a radio wave from the antenna 21 to the electronic tag 93 and receives, by the antenna 21, product information from the electronic tag 93 activated by the radio wave. At least when receiving the product information, the communicator 20 measures the received signal strength indication of the wireless signal (radio wave). When receiving the product information from the electronic tag 93, the communicator 20 transmits the received signal strength indication in addition to the product information to the main computer 10.

Moreover, the reader device 2 may include a weight sensor configured to measure the weight of an object put on the reader device 2. In this case, it is possible to determine whether or not a product 91 is on the reader device 2 based on a measurement result by the weight sensor, and therefore, the weight sensor may be used also as the trigger-sensing device 18.

(2.3) Operation of Shopping Assistance System

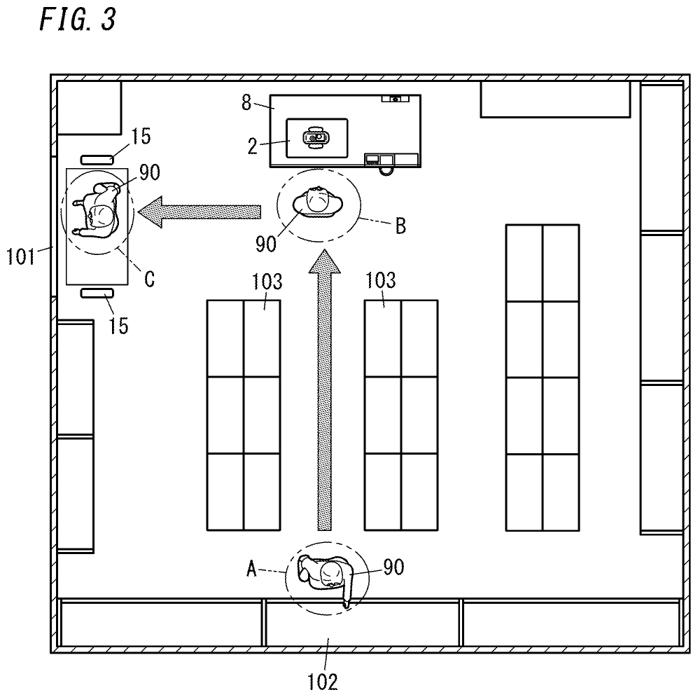

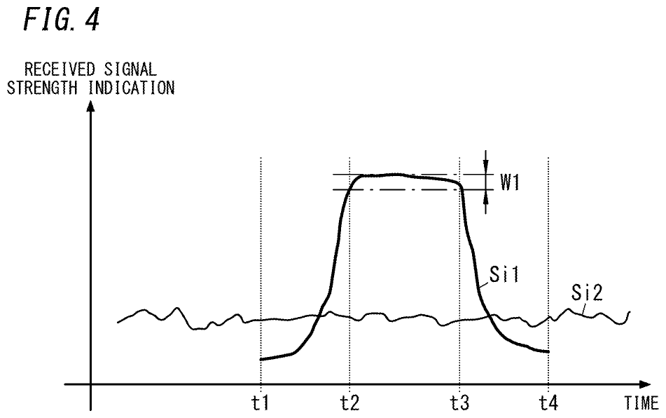

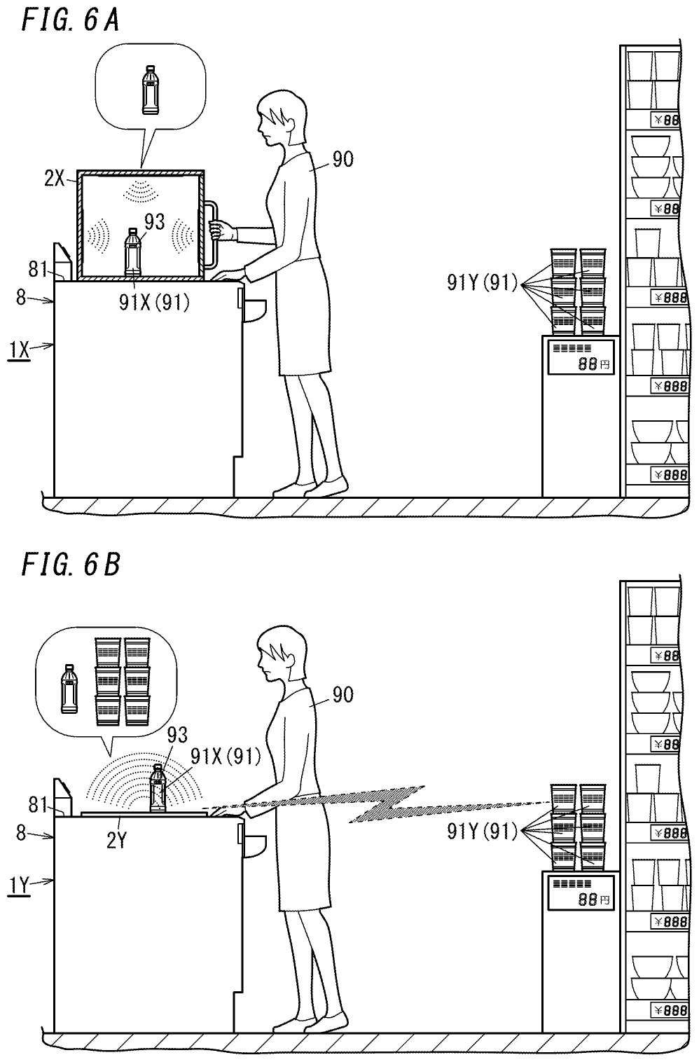

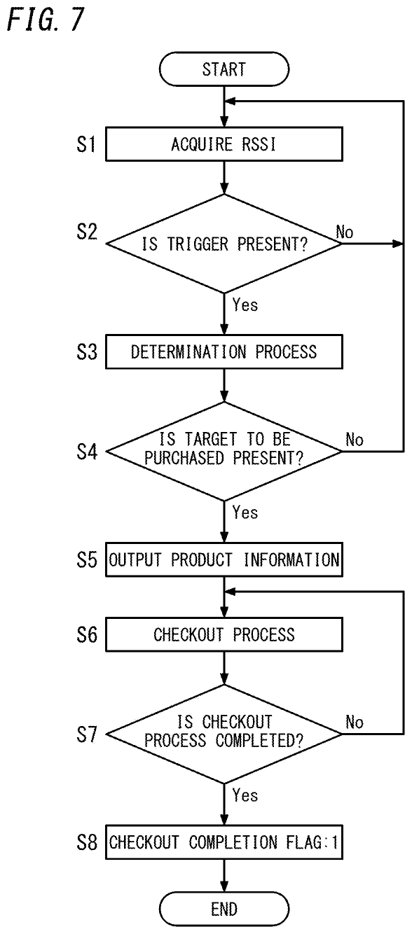

With reference to FIGS. 3 to 8, operation of the shopping assistance system 1 according to the present embodiment, that is, a shopping assistance method by using the shopping assistance system 1 will be described below. FIG. 3 is a layout of a retail store in which the shopping assistance system 1 is introduced. FIG. 4 is a waveform diagram illustrating an example of the change of the received signal strength indication over time, where the abscissa is a time axis, and the ordinate represents the received signal strength indication. FIG. 5 is a view schematically illustrating operation according to shopping by a customer 90 based on the shopping assistance system 1. FIGS. 6A and 6B are views schematically illustrating operation according to shopping by the customer 90 respectively based on shopping assistance systems 1X and 1Y according to a comparative example. In FIGS. 5, 6A, and 6B, the supply unit 41 and the like are accordingly omitted. FIG. 7 is a flow chart showing an operation of the shopping assistance system 1. FIG. 8 is a view schematically illustrating operation (operation performed when the customer exits a store) according to shopping by the customer 90 based on the shopping assistance system 1.

Here, it is assumed, for example, as shown in FIG. 3, the customer 90 picks up, from a refrigerator, a product 91 as an object to be purchased, passes between a pair of racks 103 to bring the product 91 to the checkout counter 8, and puts the product 91 in the prescribed area on the checkout counter 8. It is also assumed that after completion of a checkout process, the customer 90 takes the product 91 away from the checkout counter 8 and passes between a pair of gate devices 15 to exit from the exit/entrance 101. That is, in the example shown in FIG. 3, the customer 90 picks up the product 91 at a location indicated by “A”, moves thereafter to a location indicated by “B”, and then moves to a location indicated by “C”.

In this case, for the product 91 which is held by the customer 90 and which is an object to be purchased, the received signal strength indication of the piece of product information at the reader device 2 changes, for example, as indicated by “Si1” in FIG. 4. That is, an action performed by the customer 90 of putting of the product 91 in the prescribed area on the checkout counter 8 causes the received signal strength indication for the product 91 to exponentially rise as shown from time points t1 to t2 in FIG. 4. As used herein, “rise” means that the received signal strength indication increases from a value lower than or equal to a first value to a value larger than a second value (>first value) with a gradient larger than or equal to a prescribed value. Then, while the product 91 is in the prescribed area on the checkout counter 8, the received signal strength indication for the product 91 maintains a substantially fixed value as shown from time points t2 to t3 in FIG. 4. Then, an action performed by the customer 90 of taking the product 91 away from the checkout counter 8 causes the received signal strength indication for the product 91 to exponentially fall as shown from time points t3 to t4 in FIG. 4.

The determining processor 12 analyzes a change of the received signal strength indication during a determination time period for each product 91 to determine whether or not each product 91 is the object to be purchased. That is, when the received signal strength indication shows the changing pattern as indicated by “Si1” in FIG. 4, a rise of the received signal strength indication is detected from the time points t1 to t2. Therefore, the determining processor 12 determines that the first condition is satisfied. At this time, the determining processor 12 may obtain, for example, the differential (temporal differentiation) value of the received signal strength indication to compare the differential value thus obtained with a threshold so as to determine whether or not the first condition is satisfied. In sum, since the differential value of the received signal strength indication corresponds to the magnitude of the “gradient” when the received signal strength indication “rises” as described above, the determining processor 12 can determine that the first condition is satisfied when the differential value is larger than or equal to the threshold.

Moreover, when the received signal strength indication shows the changing pattern as indicated by “Si1” in FIG. 4, the variation width of the received signal strength indication for a specified time (for example, one second) is smaller than or equal to a prescribed width W1 during a period between the time points t2 to t3, and therefore, the determining processor 12 determines that the second condition is satisfied. As a result, the determining processor 12 determines that the received signal strength indication for the product 91 satisfies the determination conditions (both the first condition and the second condition) and thus determines that the product 91 is the object to be purchased. Here, the prescribed width W1 may be a fixed value or a value corresponding to a prescribed ratio (for example, several percentages) with reference to an actually measured value of the received signal strength indication.

In contrast, for example, for a product simply displayed, for example, in the vicinity of the checkout counter 8, the received signal strength indication of the product information at the reader device 2 maintains a substantially fixed value as indicated by “Si2” in FIG. 4. Thus, the product simply displayed in the vicinity of the checkout counter 8 does not satisfy the first condition. As a result, the determining processor 12 determines that the received signal strength indication for the product simply displayed in the vicinity of the checkout counter 8 does not satisfy the determination conditions (both the first condition and the second condition) and thus determines that the product 91 is not the object to be purchased.

Accordingly, as illustrated in FIG. 5, in the shopping assistance system 1 according to the present embodiment, it is determined that a product 91X put in the prescribed area on the checkout counter 8, that is, on the reader device 2 is the object to be purchased. In contrast, the shopping assistance system 1 determines that products 91Y simply displayed in the vicinity of the checkout counter 8 are not objects to be purchased. Thus, in the shopping assistance system 1, for example, the reader device 2 may read pieces of product information on products 91Y which are not objects to be purchased, such as products 91Y displayed in the vicinity of the checkout counter 8, but the product 91X as the object to be purchased can be distinguished from these products 91Y. In FIG. 5, the product 91 determined as the object to be purchased by the shopping assistance system 1 is conceptually shown in a balloon.

In contrast, the shopping assistance systems 1X and 1Y according to the comparative example have the following problems. Here, neither the shopping assistance system 1X nor 1Y according to the comparative example has a function of determining whether or not the product 91 is the object to be purchased based on a change of received signal strength indication over time. As illustrated in FIG. 6A, the shopping assistance system 1X according to a first comparative example includes a reader device 2X which includes a housing having a radio wave shielding function and which is of an encapsulation-type. As illustrated in FIG. 6B, the shopping assistance system 1Y according to a second comparative example includes a reader device 2Y which is of an open-type similar to the present embodiment. In FIGS. 6A and 6B, the product 91 which is identified as the object to be purchased by the shopping assistance systems 1X and 1Y is conceptually shown in a balloon.

In the shopping assistance system 1X according to the first comparative example, the reader device 2X of encapsulation-type communicates with an electronic tag 93 in an internal space of the housing having the radio wave shielding function. Thus, radio waves are less likely to leak from the internal space of the housing, and an object whose product information is to be read by the reader device 2X can be limited to the product 91X as the object to be purchased. However, such a reader device 2X of encapsulation-type requires an operation of putting the product 91X in the internal space of the housing. In particular, in such a situation where the customer 90 holds baggage by both hands, it is difficult for the customer 90 to open and close a door of the housing. Moreover, for example, when a radio wave from an electronic tag 93 located out of the housing passes through the housing, and when the door is forgotten to be closed, the reader device 2X may read pieces of product information from the electronic tags 93 of the products 91Y located out of the housing. Thus, the products 91Y which are not the objects to be purchased may be erroneously detected as objects to be purchased.

In the shopping assistance system 1Y according to the second comparative example, the reader device 2Y of open-type may read not only the piece of product information on the product 91X put in the prescribed area on the checkout counter 8, that is on the reader device 2Y but also the pieces of product information on the products 91Y displayed in the vicinity of the checkout counter 8. Thus, the products 91Y which are not the objects to be purchased may be erroneously detected as objects to be purchased.

The shopping assistance system 1 according to the present embodiment, as described above, can distinguish the products 91Y which are not the objects to be purchased, such as products 91Y displayed in the vicinity of the checkout counter 8, from the product 91X as the object to be purchased. That is, the shopping assistance system 1 provides the advantage that erroneous determination as an object to be purchased is less likely to occur. In addition, since the shopping assistance system 1 includes the reader device 2 of an open-type, the shopping assistance system 1 does not require operations of opening and closing the door of the housing as in the shopping assistance system 1X of the first comparative example and are thus convenient.

Next, general operation of the shopping assistance system 1 according to the present embodiment will be described with reference to FIG. 7.

The shopping assistance system 1 acquires values of a received signal strength indication (RSSI) by the strength acquirer 11 (S1) at first when reception of product information is performed. Then, the shopping assistance system 1 determines the presence or absence of a trigger (S2). That is, since the trigger is not sensed by the trigger-sensing device 18 until at least one product 91 is put in the prescribed area, the shopping assistance system 1 determines that the trigger is absent (S2: No), and the process returns to process S1. In contrast, when the at least one product 91 is put in the prescribed area, the trigger-sensing device 18 senses the trigger, and therefore, the shopping assistance system 1 determines that the trigger is present (S2: Yes) and executes a determining process (S3).

Note that the determining process is not always executed, but when the shielding object-sensing device 17 senses the shielding object, the main computer 10 temporarily interrupts the determining process performed by the determining processor 12. For example, when a person (customer 90) as a shielding object passes between the reader device 2 and a product 91 displayed in the vicinity of the checkout counter 8, the received signal strength indication of the product 91 temporarily decreases and thereafter rises. To avoid the influence of a change of the received signal strength indication caused due to the shielding object as described above, the determining process is preferably interrupted for a fixed time when the shielding object-sensing device 17 senses a shielding object.

In the determining process, the determining processor 12 of the shopping assistance system 1 determines whether or not the at least one product 91 is an object to be purchased for each of the at least one product 91 based on a change of the received signal strength indication over time. The shopping assistance system 1 determines, based on a result of the determining process, whether or not the at least one product 91 as the object to be purchased is present (S4). At this time, if it is determined that the object to be purchased is absent (S4: No), the process performed by the shopping assistance system 1 returns to process S1. In contrast, if it is determined that the object to be purchased is present (S4: Yes), the selector 14 of the shopping assistance system 1 outputs, to the checkout system 3, the piece of product information on the at least one product 91 as the object to be purchased (S5).

The checkout system 3 which has received the piece of product information executes a checkout process (S6). The shopping assistance system 1 determines whether or not the checkout process by the checkout system 3 is completed (S7). If the checkout process is not completed (S7: No), the process performed by the shopping assistance system 1 returns to process S6. In contrast, when the customer 90 performs checkout and the checkout of the at least one product 91 is thus completed, the checkout system 3 notifies the main computer 10 of the completion of the checkout process. At this time, the shopping assistance system 1 provides, to the customer 90, messages such as “Please take the product. Thank you very much.” with a display, voice, or the like. When the main computer 10 of the shopping assistance system 1 receives the notification of the completion of the checkout process, the shopping assistance system 1 determines that the checkout process is completed (S7: Yes) and changes the value of a checkout completion flag stored in the memory of the main computer 10 in association with the piece of product information to “1” (S8).

The checkout completion flag is used to determine whether or not the checkout process has been performed on the piece of product information read from the electronic tag 93 by the gate device 15. That is, as illustrated in FIG. 8, when the customer 90 passes through the exit/entrance 101 to go out of the retail store (exits the retail store), the gate device 15 communicates, in a non-contact manner, with the electronic tag 93 attached to the at least one product 91 in the container 92 held by the customer 90. Whether or not the checkout process has been completed is determined for the piece of information read from the electronic tag 93 by the gate device 15 based on the value of a checkout completion flag stored in association with the piece of information in the memory of the main computer 10. That is, if the value of a checkout completion flag corresponding to the piece of information read from the electronic tag 93 by the gate device 15 is “1”, it is determined that the checkout process of the at least one product 91 is completed, and therefore, the notification device 16 does not execute the notification process. In contrast, if the value of the checkout completion flag corresponding to the piece of information read from the electronic tag 93 by the gate device 15 is “0”, it is determined that the checkout process of the at least one product 91 is incomplete, and therefore, the notification device 16 executes the notification process.

Here, storage of the value of the checkout completion flag is not limited to the memory of the main computer 10 but a database configured on a server device or cloud (cloud computing) connected to the shopping assistance system 1 via, for example, a network. In this case, whether or not the checkout process is completed for the piece of information read from the electronic tag 93 by the gate device 15 is determined by inquiring the database via, for example, a network by the shopping assistance system 1.

Moreover, when the checkout process is not completed for the piece of information read from the electronic tag 93 by the gate device 15, the shopping assistance system 1 may interlock the gate device 15 with an automatic door at the exit/entrance 101 so that the automatic door at the exit/entrance 101 is not opened.

As described above, when the customer 90 simply puts the at least one product 91 as the object to be purchased on the checkout counter 8, the shopping assistance system 1 can identify the at least one product 91 as the object to be purchased. Thus, the shopping assistance system 1 enables shopping to be efficiency performed.

(3) Variations

The first embodiment is only one of various embodiments of the present disclosure. Various modifications may be made to the first embodiment depending on design and the like as long as the object of the present disclosure is achieved. Moreover, functions similar to those of the shopping assistance system 1 may be realized by a shopping assistance method, a (computer) program, a non-transitory storage medium storing a program, or the like. The shopping assistance method according to one aspect includes acquiring values of a received signal strength indication at the reader device 2 while the reader device 2 performs wireless communication with an electronic tag 93 attached to at least one product 91. The reader device 2 is configured to perform the wireless communication with the electronic tag 93 by using a radio wave as a medium to read a piece of product information on the at least one product 91. The shopping assistance method further includes determining, for each of the at least one product 91 whether or not the at least one product 91 is an object to be purchased based on a change of the received signal strength indication over time. A program according to one aspect is a program configured to cause a computer system to execute a process of acquiring values of a received signal strength indication at a reader device 2 while the reader device 2 performs wireless communication with an electronic tag 93 attached to at least one product 91 and a process of determining whether or not the at least one product 91 is an object to be purchased. The reader device 2 is configured to perform the wireless communication with the electronic tag 93 by using a radio wave as a medium to read a piece of product information on the at least one product 91. In the process of determining whether or not the at least one product 91 is the object to be purchased, it is determined, for each of the at least one product 91, whether or not the at least one product 91 is an object to be purchased based on a change of the received signal strength indication over time.

Variations of the first embodiment will be described below. The variations described below are applicable accordingly in combination.

The shopping assistance system 1 in the present disclosure includes a computer system, for example, in the main computer 10. The computer system includes a processor and memory as hardware as main components. The processor executes a program stored in the memory of the computer system, thereby realizing the function as the shopping assistance system 1 of the present disclosure. The program may be stored in the memory of the computer system in advance, may be provided over a telecommunications network, or may be provided as a non-transitory recording medium such as a memory card, an optical disc, or hard disk drive which stores the program and which is readable by the computer system. The processor of the computer system includes one or more electronic circuits including a semiconductor integrated circuit (IC) or a large-scale integrated circuit (LSI). The integrated circuit such as IC or LSI mentioned herein may be referred to in another way, depending on the degree of the integration and includes integrated circuits called system LSI, very-large-scale integration (VLSI), or ultra-large-scale integration (ULSI). A Field-Programmable Gate Array (FPGA), which is programmable after fabrication of the LSI, or a logical device which allows reconfiguration of connections in LSI or reconfiguration of circuit cells in LSI may be adopted as the processor. Those electronic circuits may be either integrated together on a single chip or distributed on multiple chips without limitation. The plurality of chips may be collected in one device or may be distributed in a plurality of devices. As mentioned herein, the computer system includes a microcontroller including one or more processors and one or more memories. Thus, the microcontroller also includes one or more electronic circuits including a semiconductor integrated circuit or a large-scale integrated circuit.

Collecting the plurality of functions in the shopping assistance system 1 in one housing is not an essential configuration of the shopping assistance system 1. The components of the shopping assistance system 1 may be distributed in a plurality of housings. Moreover, at least some functions of the shopping assistance system 1 may be realized by, for example, a server device, cloud (cloud computing), and the like. In contrast, in the first embodiment, at least some functions of the shopping assistance system 1 distributed in a plurality of device may be collected in one housing.

Moreover, the application of the shopping assistance system 1 is not limited to application in convenience stores, but the shopping assistance system 1 may be installed in stores other than convenience stores.

Furthermore, the electronic tag 93 is not limited to the passive-type RF tag but may be an active-type RF tag. The reader device 2 may combine a means for image recognition or the like with information read from the electronic tag 93 to read product information.

Moreover, the shopping assistance system 1 may be used not only in a situation where purchase of at least one product 91 is possible without requiring operation by a clerk as illustrated in the case of the first embodiment but also used in a situation where a clerk is at a checkout counter as in the case of a so-called manned checkout counter, for example.

Moreover, the container 92 in which the at least one product 91 is to be stored is not limited to a bag but may be, for example, a pouch (plastic shopping bag), a basket, a box, or a cart. Bagging of storing the at least one product 91 in the container 92 does not have to be performed by a sales clerk or a customer 90. For example, the at least one product 91 may be displayed in a retail store in a state where the at least one product 91 is stored in the container 92, or the bagging may be automatically performed by using a bagging device or the like. Moreover, the configuration of the reader device 2 is not limited to a configuration where the reader device 2 reads the piece of product information from the electronic tag 93 attached to the at least one product 91 in a state where the at least one product 91 is stored in the container 92. The reader device 2 may read the piece of product information from the electronic tag 93 of the at least one product 91 which is not stored in the container 92. In this case, after the reader device 2 reads the piece of product information, the at least one product 91 may be stored in the container 92 or does not have to be stored in the container 92.

Moreover, that the main computer 10 is configured to communicate with the checkout system 3 is not an essential configuration of the shopping assistance system 1. The main computer 10 does not have to be configured to communicate with the checkout system 3. For example, the main computer 10 itself may have a function of performing the checkout process of a product 91 based on product information.

Moreover, the checkout process does not have to be performed in a retail store. For example, the retail store only identifies the customer 90 who purchases at least one product 91, and later, the checkout process using, for example, a credit card or the like may be executed. Identification of the customer 90 is realizable by, for example, communication with a personal digital assistant terminal (for example, smartphone) carried by the customer 90, or biometrics authentication (including face authentication), or the like.

Moreover, the configuration of the display device 42 is not limited to a configuration in which an image is projected onto an object by a projection mapping technique, but the display device 42 may be, for example, touch panel display. Furthermore, as the input device 43, for example, an input device 43 including a mechanical switch may be adopted into at least part of an input means of the customer 90 to the shopping assistance system 1.

Moreover, the shopping assistance system 1 may further include a writing device configured to write writing information to the electronic tag 93 attached to the at least one product 91. Specifically, a reader device 2 including a reader writer configured to read and write data (information) from and to the electronic tag 93 may be used also as the writing device. For example, the writing device writes, to an electronic tag 93, checkout completion information representing that the checkout process is completed for a product 91 to which the electronic tag 93 is attached. In this case, the gate device 15 determines whether or not the checkout completion information is written to the electronic tag 93, and if the checkout completion information is not written to the electronic tag 93, it is possible to perform notification by the notification device 16. That is, when the writing device realizes a function of a so-called “kill tag”, it is possible to confirm that the checkout process is normally completed for a product 91 which is about to be brought out of the retail store without executing a process of changing the value of the checkout completion flag to “1” by the main computer 10.

Moreover, the trigger-sensing device 18 is not an essential component of the shopping assistance system 1. The main computer 10 may start the determining process by the determining processor 12, for example, with reception of a specific operation given to the input device 43 by a customer 90 as a trigger. That is, a start timing of the determining process does not necessarily have to be automatically determined by an objective sensor or the like but may be determined by an operation given by a customer 90.

Moreover, the reader device 2 is not limited to be an open type but may include a shield or the like for reducing leakage of a radio wave from the prescribed area. In this case, the entire periphery of the prescribed area does not have to be completely closed by the shield. For example, the prescribed area may be open in front and upward directions. Moreover, the shield has at least a radio wave shielding function and may thus have, for example, a mesh shape (or a shape having through holes). The antenna 21 is not limited to an antenna for a circularly polarized wave but may be, for example, an antenna for an ellipse polarized wave, a linearly polarized wave, or the like.

### Second Embodiment

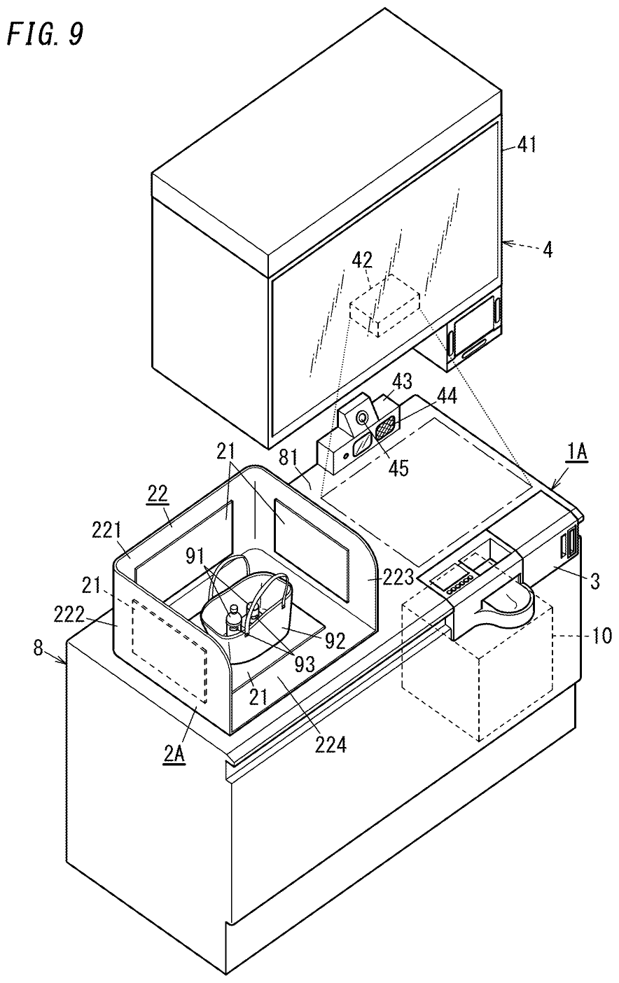

As illustrated in FIG. 9, a shopping assistance system 1A according to the present embodiment is different from the shopping assistance system 1 of the first embodiment in that a reader device 2A is configured to perform wireless communication with an electronic tag 93 via a plurality of antennas 21 which are different from each other in at least one of location or orientation. In the following description, components similar to those in the first embodiment are denoted by the same reference signs as those in the first embodiment, and the description thereof is accordingly omitted.

The reader device 2A includes, for example, as shown in FIG. 9, a housing 22 installed on an upper surface 81 of a checkout counter 8. Note that inclusion of the housing 22 in components of the reader device 2A is not essential for the shopping assistance system 1. The housing 22 does not have to be included in the components of the reader device 2A.

The housing 22 has a radio wave shielding function and is provided to surround a prescribed area. In other words, the prescribed area is defined by the housing 22, and a range (space) surrounded by the housing 22 functions as the prescribed area. Thus, the housing 22 functions as a shield for reducing leakage of a radio wave from the prescribed area.

In the present embodiment, the housing 22 has a shape of a box with its upper surface and front surface being open. That is, the housing 22 includes a back wall 221, a left side wall 222, a right side wall 223, and a bottom panel 224. The prescribed area is a space surrounded by the back wall 221, the left side wall 222, the right side wall 223, and the bottom panel 224.

The plurality of antennas 21 are provided at the back wall 221, the left side wall 222, the right side wall 223, and the bottom panel 224. In the present embodiment, the plurality of antennas 21 are four patch antennas (microstrip antennas) provided on inner side surfaces (i.e., surfaces facing the prescribed area) of the back wall 221, the left side wall 222, the right side wall 223, and the bottom panel 224. Thus, the antenna 21 provided on the back wall 221 has directionality in the forward and rearward directions, the pair of antennas 21 provided on the left side wall 222 and the right side wall 223 have directionality in the left and right directions, and the antenna 21 provided on the bottom panel 224 has directionality in the upward and downward directions. Each antenna 21 has a surface which may be covered with a spacer film which is electrically insulating. Thus, it is possible to reduce contact between the electronic tag 93 and the antennas 21 provided on the inner side surfaces of the back wall 221 and the like, and it is possible to improve a reading ratio of product information from the electronic tag 93.

In other words, of the plurality of antennas 21, at least two antennas 21 are oriented in directions different from each other. In the present embodiment, the plurality of antennas 21 include three or more antennas 21 having directionalities along three axes orthogonal to one another. Via the plurality of antennas 21, the reader device 2A transmits and receives a radio wave as a communication medium to and from an electronic tag 93 located in the prescribed area surrounded by the housing 22 so as to perform wireless communication. That is, the plurality of antennas 21 are arranged to surround at least one product 91.

Note that the configuration of the reader device 2A is not limited to a configuration including four antennas 21, but the reader device 2A may include two, three, or more than or equal to five antennas 21. For example, the housing 22 may have a shape formed by omitting the back wall 221 and displacing the left side wall 222 and the right side wall 223 to be obliquely oriented to form a V-shape in plan view so as to bring rear edges of the left side wall 222 and the right side wall 223 are in contact with each other. In this case, the two antennas 21 provided on the left side wall 222 and the right side wall 223 are respectively located at rear left and rear right locations of the prescribed area. Alternatively, as another example, the housing 22 may have a shape formed by omitting the left side wall 222 and the right side wall 223 and curving the back wall 221 such that a central part of the back wall 221 rearwardly protrudes. In this case, the antennas 21 provided on the back wall 221 have a curved surface. Alternatively, as still another example, from the housing 22, the left side wall 222 and the right side wall 223 may be omitted, and the housing 22 may have a top board at a location facing the bottom panel 224, and the antenna 21 is provided on an inner side surface (i.e., a surface facing the prescribed area) of the top board. In this case, the three antennas 21 provided on the back wall 221, the bottom panel 224, and the top board are located behind, under, and over the prescribed area.

In the present embodiment, the strength acquirer 11 acquires, values of a received signal strength indication for each antenna 21. That is, in the present embodiment, the reader device 2A has a plurality of antennas 21, and therefore, the strength acquirer 11 individually acquires the values of the received signal strength indication for each of the plurality of antennas 21. The strength acquirer 11 stores the values of the received signal strength indication acquired from the reader device 2A in memory of the main computer 10 for each antenna 21.

The determining processor 12 is configured to perform determination based on received signal strength indications for the plurality of antennas 21. That is, in the present embodiment, the strength acquirer 11 individually acquires values of the received signal strength indication for each of the plurality of plurality of antennas 21, and therefore, the determining processor 12 determines whether or not individual products 91 are the objects to be purchased based on combinations of the values of the received signal strength indications for the plurality of antennas 21.

Here, various types of algorithms are included in examples of a determination algorithm of the determining processor 12 when the determining process is performed based on the combination of the values of the received signal strength indications for the plurality of antennas 21. For example, the determining processor 12 determines that the determination conditions are satisfied when for each of at least two antennas 21, a change of the received signal strength indication over time satisfies the first condition and the second condition. For another example, the determining processor 12 determines that the determination conditions are satisfied when for all the antennas 21, when changes of the received signal strength indications over time satisfy the first condition and the second condition. For still another example, the determining processor 12 may execute the determining process with the plurality of antennas 21 being discriminated between internally oriented antennas 21 for receiving a radio wave from an interior of the prescribed area and externally oriented antennas 21 for receiving a radio wave from an exterior of the prescribed area. That is, for example, when the values of the received signal strength indications greater than or equal to the threshold are detected only by the internally oriented antennas 21, the determining processor 12 determines that the determination conditions are satisfied.

With the above-described configuration, the shopping assistance system 1A determines whether or not the at least one product 91 is the object to be purchased based on the received signal strength indications for the plurality of antennas 21. This improves determination accuracy of determining whether or not the at least one product 91 is the object to be purchased.

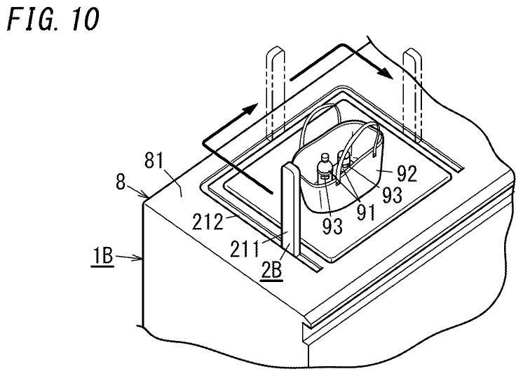

As a shopping assistance system 1B according to a variation of the second embodiment, a reader device 2B may include, as illustrated in FIG. 10, one antenna member 211 and a displacement mechanism 212 configured to displace the antenna member 211. In this case, displacing the antenna member 211 by the displacement mechanism 212 enables the antenna member 211 to be used as at least two antennas 21 of a plurality of antennas 21. In the example shown in FIG. 10, the displacement mechanism 212 displaces the antenna member 211 having a bar shape along a substantially C-shaped rail surrounding the prescribed area. Thus, the location and orientation of the antenna member 211 change over time. The reader device 2B uses the antenna member 211 at different time points to resemble a plurality of antennas 21 and perform wireless communication with the electronic tag 93 via the plurality of antennas 21. Furthermore, a communication area of the antenna 21 may be displaced by beamforming.

As another variation of the second embodiment, it is not necessary that all the plurality of antennas 21 are provided to the checkout counter 8 and one or some of the plurality of antennas 21 may be installed in a distributed manner, for example, on a ceiling of a retail store. In this case, determining processor 12 can estimate a moving route of a customer 90 holding at least one product 91 based on, for example, a change of received signal strength indications over time for the plurality of antennas 21. Therefore, when the customer 90 holding the at least one product 91 approaches the checkout counter 8 from the front, the determining processor 12 preferably determines that the determination conditions are satisfied.

The various configurations (including the variation) described in the second embodiment are adoptable accordingly in combination with the various configurations (including the variations) described in the first embodiment.

### Third Embodiment

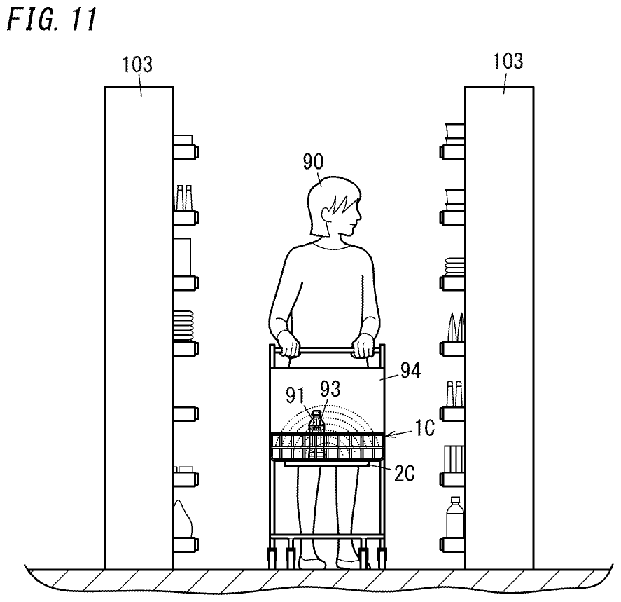

As illustrated in FIG. 11, a shopping assistance system 1C according to the present embodiment is different from the shopping assistance system 1 of the first embodiment in that a reader device 2C is not fixed to a fixed location but is provided to a cart 94. In the following description, components similar to those in the first embodiment are denoted by the same reference signs as those in the first embodiment, and the description thereof is accordingly omitted.

That is, in the present embodiment, the reader device 2C is not fixed to a fixed location but is provided to the cart 94 (shopping cart) which is movable in a retail store. In the example shown in FIG. 11, the reader device 2C is attached to a lower surface of a carrier of the cart 94 and performs wireless communication with an electronic tag 93 in a prescribed area defined on the carrier of the cart 94. That is, in a state where a product 91 is on the carrier of the cart 94, the reader device 2C performs wireless communication with an electronic tag 93 attached to the product 91 and executes reading of product information. In the present embodiment, the reader device 2 is configured to perform two-way communication with the main computer 10 provided to the checkout counter 8 based on wireless communication by using a radio wave as a medium.

In the shopping assistance system 1C, a customer 90 moves in the retail store while the customer pushes the cart 94, and the customer 90 picks up, from a rack 103 or the like, at least one product 91 to be purchased and puts the at least one product 91 on the carrier of the cart 94. Thus, in the reader device 2C provided to the cart 94, a received signal strength indication regarding the at least one product 91 put on the carrier shows a specific changing pattern. Accordingly, the determining processor 12 determines that the received signal strength indication regarding the at least one product 91 put by the customer 90 on the carrier of the cart 94 satisfies the determination conditions and determines that the at least one product 91 is the object to be purchased.

With the above-described configuration, the customer 90 does not have to put the at least one product 91 on the checkout counter 8, and it is also possible, for example, to complete purchase of the at least one product 91 without the customer 90 passing through the checkout counter 8.

The various configurations (including variations) described in the third embodiment are adoptable accordingly in combination with the various configurations (including the variations) described in the first embodiment or the second embodiment.

### SUMMARY

As described above, a shopping assistance system (1, 1A, 1B, 1C) of a first aspect includes a strength acquirer (11) and a determining processor (12). The strength acquirer (11) is configured to acquire values of a received signal strength indication at a reader device (2, 2A, 2B, 2C) while the reader device (2, 2A, 2B, 2C) performs wireless communication with an electronic tag (93) attached to at least one product (91). The reader device (2, 2A, 2B, 2C) is configured to perform the wireless communication with the electronic tag (93) by using a radio wave as a medium to read a piece of product information on the at least one product (91). The determining processor (12) is configured to make, for each of the at least one product (91), a determination of whether or not the at least one product (91) is an object to be purchased based on a change of the received signal strength indication over time.

With this aspect, for example, the reader device (2) may read pieces of product information on products (91) which are not objects to be purchased, such as products (91) displayed in the vicinity of the reader device (2, 2A, 2B, 2C), but it is possible to distinguish these products (91) from the object to be purchased. Thus, the shopping assistance system (1, 1A, 1B, 1C) provides the advantage that erroneous determination as an object to be purchased is less likely to occur.

A shopping assistance system (1, 1A, 1B, 1C) of a second aspect referring to the first aspect further includes an information acquirer (13) and a selector (14). The information acquirer (13) is configured to acquire a plurality of pieces of product information on a plurality of products (91) from the reader device (2, 2A, 2B, 2C). The selector (14) is configured to select the piece of product information on the object to be purchased from the plurality of pieces of product information based on a result of the determination made by the determining processor (12).

This aspect automates not only identification of the at least one product (91) as the object to be purchased but also selection of the piece of product information on the at least one product (91) as the object to be purchased.

In a shopping assistance system (1, 1A, 1B, 1C) of a third aspect referring to the second aspect, the selector (14) is configured to output the piece of product information on the object to be purchased to a checkout system (3) configured to perform a checkout process on the at least one product (91).

This aspect enables the piece of product information selected by the selector (14) to be used in the checkout process performed by the checkout system (3).

A shopping assistance system (1, 1A, 1B, 1C) of a fourth aspect referring to the third aspect further includes a gate device (15) and a notification device (16). The gate device (15) is installed at an exit/entrance (101) in a sales space and is configured to perform wireless communication with the electronic tag (93) to read the piece of product information. The notification device (16) is configured to execute a notification process when the piece of product information read by the gate device (15) is not subjected to the checkout process.

With this aspect, it is possible to control that one or more products (91) on which the checkout process is not executed are brought out of the sales space.

In a shopping assistance system (1, 1A, 1B, 1C) of a fifth aspect referring to any one of the first to fourth aspects, the reader device (2, 2A, 2B, 2C) is configured to perform the wireless communication with the electronic tag (93) via a plurality of antennas (21) different from each other in at least location or orientation. The strength acquirer (11) is configured to acquire a plurality of the received signal strength indications from the plurality of antennas (21), and the determining processor (12) is configured to make the determination based on the received signal strength indications from the plurality of antennas (21).

With this aspect, it is possible to improve determination accuracy for a determination whether or not the at least one product (91) is the object to be purchased as compared to a case where the determination is made based on the received signal strength indication from one antenna (21).

In a shopping assistance system (1, 1A, 1B, 1C) of a sixth aspect referring to the fifth aspect, of the plurality of antennas (21), at least two antennas (21) are oriented in directions different from each other.

With this aspect, the reader device (2, 2A, 2B, 2C) performs the wireless communication with the electronic tag (93) in a plurality of directions, and therefore, it is possible to improve determination accuracy for a determination whether or not the at least one product (91) is the object to be purchased.

In a shopping assistance system (1, 1A, 1B, 1C) of a seventh aspect referring to the fifth of sixth aspect, the plurality of antennas (21) are arranged to surround the at least one product (91).

With this aspect, since the determination is performed based on the received signal strength indications at the plurality of antennas (21) surrounding the at least one product (91), it is possible to improve determination accuracy for a determination whether or not the at least one product (91) is the object to be purchased.

In a shopping assistance system (1, 1A, 1B, 1C) of an eighth aspect referring to any one of the fifth to seventh aspects, the reader device (2, 2A, 2B, 2C) includes one antenna member (211) and a displacement mechanism (212) configured to displace the one antenna member (211). The one antenna member (211) is displaced by the displacement mechanism (212) such that the one antenna member (211) is used as at least two antennas (21) of the plurality of antennas (21).

With this aspect, at least two antennas (21) of the plurality of antennas (21) are realizable by one antenna member (211), and it is thus possible to reduce the number of antenna members (211) required.

In a shopping assistance system (1, 1A, 1B, 1C) of a ninth aspect referring to any one of the first to eighth aspects, a condition based on which it is determined that the at least one product (91) is the object to be purchased includes at least detection of a rise of the received signal strength indication.

With this aspect, putting the at least one product (91) in a prescribed area causes the rise of the received signal strength indication regarding the at least one product (91), and it is possible to determine, based on the rise, that the at least one product (91) is the object to be purchased. Thus, it is possible to improve determination accuracy for a determination whether or not the at least one product (91) is the object to be purchased.

In a shopping assistance system (1, 1A, 1B, 1C) of a tenth aspect referring to any one of the first to ninth aspects, a condition based on which it is determined that the at least one product (91) is the object to be purchased includes at least that a variation width of the received signal strength indication within a specified time is smaller than or equal to a prescribed width.

With this aspect, based on the received signal strength indication regarding the at least one product (91) being substantially constant while the at least one product (91) is in a prescribed area, it is possible to determine that the at least one product (91) is the object to be purchased. Thus, it is possible to improve determination accuracy for a determination whether or not the at least one product (91) is the object to be purchased.

A shopping assistance system (1, 1A, 1B, 1C) of an eleventh aspect referring to any one of the first to tenth aspects further includes a shielding object-sensing device (17) configured to sense presence and absence of a shielding object that shields a radio wave between the reader device (2, 2A, 2B, 2C) and the electronic tag (93).

With this aspect, for example, when the shielding object-sensing device (17) senses the shielding object, the determination by the determining processor (12) is interrupted for a prescribed time to reduce the influence of a change of the received signal strength indication caused due to the shielding object. Thus, it is possible to improve determination accuracy for a determination whether or not the at least one product (91) is the object to be purchased.

A shopping assistance system (1, 1A, 1B, 1C) of a twelfth aspect referring to any one of the first to eleventh aspects further includes a trigger-sensing device (18) configured to sense that the at least one product (91) is put in a prescribed area.

With this aspect, for example, only when the trigger-sensing device (18) senses that the at least one product (91) is put in the prescribed area, the determining processor (12) executes the determination to avoid unnecessary determination due to noise or the like. Thus, it is possible to improve determination accuracy for a determination whether or not the at least one product (91) is the object to be purchased.

A shopping assistance system (1, 1A, 1B, 1C) of a thirteenth aspect referring to any one of the first to twelfth aspects further includes the reader device (2, 2A, 2B, 2C).

With this aspect, it is possible to realize operation as the shopping assistance system (1, 1A, 1B, 1C) without separately preparing the reader device (2, 2A, 2B, 2C).

In a shopping assistance system (1, 1A, 1B, 1C) of a fourteenth aspect referring to the thirteenth aspect, the reader device (2, 2A, 2B, 2C) is fixed to a fixed location.

With this aspect, the reader device (2, 2A, 2B, 2C) is easily supplied with electric power.

A shopping assistance method of a fifteenth aspect includes: acquiring values of a received signal strength indication at a reader device while the reader device performs wireless communication with an electronic tag attached to at least one product; and determining, for each of the at least one product, whether or not the at least one product is an object to be purchased based on a change of the received signal strength indication over time. The reader device is configured to perform the wireless communication with the electronic tag by using a radio wave as a medium to read a piece of product information on the at least one product.

With this aspect, for example, the reader device (2) may read pieces of product information on products (91) which are not objects to be purchased, such as products (91) displayed in the vicinity of the reader device (2, 2A, 2B, 2C), but it is possible to distinguish these products (91) from the object to be purchased. Thus, the shopping assistance method provides the advantage that erroneous determination as an object to be purchased is less likely to occur.

A program of a sixteenth aspect is a program configured to cause a computer system to execute a process of acquiring values of a received signal strength indication at a reader device while the reader device performs wireless communication with an electronic tag attached to at least one product and a process of determining whether or not the at least one product is an object to be purchased. The latter process is determining, for each of the at least one product, whether or not the at least one product is an object to be purchased based on a change of the received signal strength indication over time. The reader device is configured to perform the wireless communication with the electronic tag by using a radio wave as a medium to read a piece of product information on the at least one product.

With this aspect, for example, the reader device (2) may read pieces of product information on products (91) which are not objects to be purchased, such as products (91) displayed in the vicinity of the reader device (2, 2A, 2B, 2C), but it is possible to distinguish these products (91) from the object to be purchased. Thus, the program provides the advantage that erroneous determination as an object to be purchased is less likely to occur.

The aspects should not be construed as limiting, but various configurations (including variations) of the shopping assistance system (1, 1A, 1B, 1C) according to the first embodiment, the second embodiment, and the third embodiment may be embodied in a shopping assistance method or a program.

The configurations of the second to fourteenth aspects are not essential configurations of the shopping assistance system (1, 1A, 1B, 1C) and may accordingly be omitted.

### REFERENCE SIGNS LIST

1, 1A, 1B, 1C SHOPPING ASSISTANCE SYSTEM
2, 2A, 2B, 2C READER DEVICE
3 CHECKOUT SYSTEM
11 STRENGTH ACQUIRER
12 DETERMINING PROCESSOR
13 INFORMATION ACQUIRER
14 SELECTOR
15 GATE DEVICE
16 NOTIFICATION DEVICE
17 SHIELDING OBJECT-SENSING DEVICE
18 TRIGGER-SENSING DEVICE
21 ANTENNA
91 PRODUCT
93 ELECTRONIC TAG
211 ANTENNA MEMBER
212 DISPLACEMENT MECHANISM

What is claimed is:

1. A shopping assistance system, comprising:
a strength acquirer configured to acquire values of a received signal strength indication at a reader device while the reader device performs wireless communication with an electronic tag attached to at least one product, the reader device being configured to perform the wireless communication with the electronic tag by using a radio wave as a medium to read a piece of product information on the at least one product; and
a determining processor configured to make, for each of the at least one product, a determination of whether or not the at least one product is an object to be purchased based on a change of the received signal strength indication over time.

2. The shopping assistance system of claim 1, further comprising:
an information acquirer configured to acquire a plurality of pieces of product information on a plurality of products from the reader device; and
a selector configured to select the piece of product information on the object to be purchased from the plurality of pieces of product information based on a result of the determination made by the determining processor.

3. The shopping assistance system of claim 2, wherein
the selector is configured to output the piece of product information on the object to be purchased to a checkout system configured to perform a checkout process on the at least one product.

4. The shopping assistance system of claim 3, further comprising:
a gate device installed at an exit/entrance in a sales space and configured to perform wireless communication with the electronic tag to read the piece of product information; and
a notification device configured to execute a notification process when the piece of product information read by the gate device is not subjected to the checkout process.

5. The shopping assistance system of claim 1, wherein
the reader device is configured to perform the wireless communication with the electronic tag via a plurality of antennas different from each other in at least location or orientation,
the strength acquirer is configured to acquire a plurality of the received signal strength indications from the plurality of antennas, and
the determining processor is configured to make the determination based on the received signal strength indications from the plurality of antennas.

6. The shopping assistance system of claim 5, wherein
of the plurality of antennas, at least two antennas are oriented in directions different from each other.

7. The shopping assistance system of claim 5, wherein
the plurality of antennas are arranged to surround the at least one product.

8. The shopping assistance system of claim 5, wherein
the reader device includes one antenna member and a displacement mechanism configured to displace the one antenna member, and
the one antenna member is displaced by the displacement mechanism such that the one antenna member serves as at least two antennas of the plurality of antennas.

9. The shopping assistance system of claim 1, wherein
a condition based on which it is determined that the at least one product is the object to be purchased includes at least detection of a rise of the received signal strength indication.

10. The shopping assistance system of claim 1, wherein
a condition based on which it is determined that the at least one product is the object to be purchased includes at least that a variation width of the received signal strength indication within a specified time is smaller than or equal to a prescribed width.

11. The shopping assistance system of claim 1, further comprising:
a shielding object-sensing device configured to sense presence and absence of a shielding object that shields the radio wave between the reader device and the electronic tag.

12. The shopping assistance system of claim 1, further comprising:
a trigger-sensing device configured to sense that the at least one product is put in a prescribed area.

13. The shopping assistance system of claim 1, further comprising:
the reader device.

14. The shopping assistance system of claim 13, wherein
the reader device is fixed to a fixed location.

15. A shopping assistance method, comprising:
acquiring values of a received signal strength indication at a reader device while the reader device performs wireless communication with an electronic tag attached to at least one product, the reader device being configured to perform the wireless communication with the electronic tag by using a radio wave as a medium to read a piece of product information on the at least one product; and
determining, for each of the at least one product, whether or not the at least one product is an object to be purchased based on a change of the received signal strength indication over time.

16. A program configured to cause
a computer system to execute
a process of acquiring values of a received signal strength indication at a reader device while the reader device performs wireless communication with an electronic tag attached to at least one product, the reader device being configured to perform the wireless communication with the electronic tag by using a radio wave as a medium to read a piece of product information on the at least one product, and
a process of determining, for each of the at least one product, whether or not the at least one product is an object to be purchased based on a change of the received signal strength indication over time.
